(19) United States
(12) Patent Application Publication
(10) Pub. No.: US 2018/0020373 A1
(43) Pub. Date: Jan. 18, 2018

(54) METHOD AND APPARATUS FOR MANAGING QUANTITY OF DATA TO BE TRANSMITTED IN A WIRELESS NETWORK

(71) Applicant: CANON KABUSHIKI KAISHA, Tokyo (JP)

(72) Inventors: Pascal VIGER, JANZE (FR); Stéphane BARON, LE RHEU (FR); Patrice NEZOU, LIFFRE (FR)

(21) Appl. No.: 15/644,621

(22) Filed: Jul. 7, 2017

(30) Foreign Application Priority Data
Jul. 13, 2016 (GB) 1612160.0

(51) Int. Cl. H04W 28/02; H04W 74/08; H04W 88/08

(52) U.S. Cl. CPC H04W 28/0278; H04W 74/0816; H04W 88/08

(57) ABSTRACT

A method of communication in a wireless network comprising a plurality of wirelessly communicating stations, one station playing the role of access point, the other stations being connected to the access point station, the method comprising by the access point station receiving at least one buffer status report from a station indicating a size of a quantity of data the station has to transmit to the access point station; storing received buffer status reports; generating a channel resource allocation for a multi-user transmission from the stations to the access point station based on stored buffer status reports; wherein the generation of a channel resource allocation further takes into account the size of any quantity of data received from the stations after the buffer status reports.

### PRIORITY CLAIM/INCORPORATION BY REFERENCE

This application claims the benefit under 35 U.S.C. §119(a)-(d) of United Kingdom Patent Application No. 1612160.0, filed on Jul. 13, 2016 and entitled “METHOD AND APPARATUS FOR MANAGING QUANTITY OF DATA TO BE TRANSMITTED IN A WIRELESS NETWORK”. The above cited patent application is incorporated herein by reference in its entirety.

### FIELD OF THE INVENTION

The present invention relates generally to communication networks and more specifically to wireless communication methods in wireless network comprising a plurality of stations, one of these stations playing the role of an access point, the other stations being connected to the access point, and corresponding devices.

The invention finds application in wireless communication networks, in particular to the access of an 802.11ax composite channel and of OFDMA Resource Units forming for instance an 802.11ax composite channel for Uplink communication to the access point. One application of the method regards wireless data communication over a wireless communication network using Carrier Sense Multiple Access with Collision Avoidance (CSMA/CA), the network being accessible by a plurality of station devices.

### BACKGROUND OF THE INVENTION

A wireless network is composed of communicating stations. Typically, one of these stations plays the role of an access point. This access point station gives access to a more global network. All other stations, the non access point stations, are connected to the access point station. Using their connection to the access point station, the non access point stations have access to the global network. They also can communicate with other non access point station through the access point station. Some protocols have recently being introduced to also allow direct communication between non access point stations. In the following, the word “station” refers to any kind of stations. We will use the wording “access point station”, or in short “access point”, to refer to the station playing the role of access point and the wording “non access point station” to refer to the other stations not playing this role.

The IEEE 802.11 MAC standard defines a way wireless local area networks (WLANs) must work at the physical and medium access control (MAC) level. Typically, the 802.11 MAC (Medium Access Control) operating mode implements the well-known Distributed Coordination Function (DCF) which relies on a contention-based mechanism based on the so-called “Carrier Sense Multiple Access with Collision Avoidance” (CSMA/CA) technique.

The 802.11 medium access protocol standard or operating mode is mainly directed to the management of communication stations waiting for the wireless medium to become idle so as to try to access to the wireless medium.

The network operating mode defined by the IEEE 802.11ac standard provides very high throughput (VHT) by, among other means, moving from the 2.4 GHz band which is deemed to be highly susceptible to interference to the 5 GHz band, thereby allowing for wider frequency contiguous channels of 80 MHz to be used, two of which may optionally be combined to get a 160 MHz composite channel as operating band of the wireless network.

The 802.11ac standard also provides control frames such as the Request-To-Send (RTS) and Clear-To-Send (CTS) frames, involved in a well-known RTS/CTS handshake, to allow reservation of composite channels of varying and predefined bandwidths of 20, 40 or 80 MHz, the composite channels being made of one or more channels that are contiguous within the operating band. The 160 MHz composite channel is possible by the combination of two 80 MHz composite channels within the 160 MHz operating band. The control frames specify the channel width (bandwidth) for the targeted (or “requested”) composite channel.

A composite channel therefore consists of a primary channel on which a given station performs EDCA backoff procedure to access the medium, and of at least one secondary channel, of for example 20 MHz each. The EDCA backoff procedure consists in randomly generate a backoff value which is a timer defining a waiting duration before the next attempt to emit on the channel when a collision has been detected. The primary channel is used by the communication stations to sense whether or not the channel is idle, and the primary channel can be extended using the secondary channel or channels to form a composite channel.

Given a tree breakdown of the operating band into elementary 20 MHz channels, some secondary channels are named tertiary or quaternary channels.

In 802.11ac, all the transmissions, and thus the possible composite channels, include the primary channel. This is because the stations perform full Carrier Sense Multiple Access/Collision Avoidance (CSMA/CA) and Network Allocation Vector (NAV) tracking on the primary channel only. The Network Allocation Vector defines a duration during which a station mustn't access the channel. The other channels are assigned as secondary channels, on which the 802.11ac stations have only capability of CCA (clear channel assessment), i.e. detection of an availability state/status (idle or busy) of said secondary channel.

An issue with the use of composite channels as defined in the 802.11n or 802.11ac is that the 802.11n and 802.11ac-compliant stations (i.e. HT stations standing for High Throughput stations) and the other legacy stations (i.e. non-HT stations compliant only with for instance 802.11a/b/g) have to co-exist within the same wireless network and thus have to share the 20 MHz channels.

To cope with this issue, the 802.11n and 802.11ac standards provide the possibility to duplicate control frames (e.g. RTS/CTS or CTS-to-Self or ACK frames to acknowledge correct or erroneous reception of the sent data) on each 20 MHz channel in an 802.11a legacy format (called as “non-HT”) to establish a protection of the requested channels forming the whole composite channel, during the TXOP. The TXOP is a bounded time interval in which stations are permitted to transfer a series of frames. A TXOP is defined by a start time and a maximum duration.

This is for any legacy 802.11a station that uses any of the 20 MHz channel involved in the composite channel to be aware of on-going communications on the 20 MHz channel used. As a result, the legacy station is prevented from initiating a new transmission until the end (as set on the NAV parameter) of the current composite channel TXOP granted to an 802.11n/ac station.

As originally proposed by 802.11n, a duplication of conventional 802.11a or “non-HT” transmission is provided to allow the two identical 20 MHz non-HT control frames to be sent simultaneously on both the primary channel and the secondary channels forming the requested and used composite channel.

This approach has been widened for 802.11ac to allow duplication over the channels forming an 80 MHz or 160 MHz composite channel. In the remainder of the present document, the “duplicated non-HT frame” or “duplicated non-HT control frame” or “duplicated control frame” means that the station device duplicates the conventional or “non-HT” transmission of a given control frame over secondary 20 MHz channels of the (40/80/160 MHz) operating band.

In practice, to request a composite channel (equal to or greater than 40 MHz) for a new TXOP, an 802.11n/ac station does an EDCA backoff procedure in the primary 20 MHz channel wherein one or more backoff counters are decremented. In parallel, it performs a channel sensing mechanism, such as a Clear-Channel-Assessment (CCA) signal detection, on the secondary channels to detect the secondary channel or channels that are idle (channel state/status is “idle”) during a PI FS interval before sending a request for the new TXOP (i.e. before the backoff counter expires).

More recently, Institute of Electrical and Electronics Engineers (IEEE) officially approved the 802.11ax task group, as the successor of 802.11ac. The primary goal of the 802.11ax task group consists in seeking for an improvement in data speed to wireless communicating devices used in dense deployment scenarios.

Recent developments in the 802.11ax standard sought to optimize usage of the composite channel by multiple stations in a wireless network having an access point (AP). Indeed, typical contents have important amount of data, for instance related to high-definition audio-visual real-time and interactive content. Furthermore, it is well-known that the performance of the CSMA/CA protocol used in the IEEE 802.11 standard deteriorates rapidly as the number of stations and the amount of traffic increase, i.e. in dense WLAN scenarios.

In this context, multi-user (MU) transmission has been considered to allow multiple simultaneous transmissions to/from different users in both downlink (DL) and uplink (UL) directions from/to the access point. In the uplink to the access point, multi-user transmissions can be used to mitigate the collision probability by allowing multiple stations to simultaneously transmit.

To actually perform such multi-user transmission, it has been proposed to split a granted 20 MHz channel into one or more sub-channels, also referred to as resource units (RUs), that are shared in the frequency domain by the multiple stations, based for instance on Orthogonal Frequency Division Multiple Access (OFDMA) technique. Each resource unit may be defined by a number of tones, the 20 MHz channel containing up to 242 usable tones. A tone corresponds to the basic subcarrier to be used for transmission.

OFDMA is a multi-user variation of OFDM which has emerged as a new key technology to improve efficiency in advanced infrastructure-based wireless networks. It combines OFDM on the physical layer with Frequency Division Multiple Access (FDMA) on the MAC layer, allowing different subcarriers to be assigned to different stations in order to increase concurrency. Adjacent sub-carriers often experience similar channel conditions and are thus grouped to sub-channels: an OFDMA sub-channel or resource unit is thus a set of sub-carriers.

The multi-user feature of OFDMA allows the access point to assign different resource units to different stations in order to increase competition. This may help to reduce contention and collisions inside 802.11 networks.

As currently envisaged, the granularity of such OFDMA sub-channels is variable and may be finer than the original 20 MHz channel band. Typically, a 2 MHz or 5 MHz sub-channel may be contemplated as a minimal width, therefore defining for instance 9 sub-channels or resource units within a single 20 MHz channel.

To support multi-user uplink, i.e. uplink transmission to the 802.11ax access point (AP) during the granted TXOP, the 802.11ax access point has to provide signaling information for the legacy stations (non-802.11ax stations) to set their NAV in order to prevent them from accessing channels during the TXOP, and for the 802.11ax stations to determine the allocation of the resource units.

It has been proposed for the access point to send a trigger frame (TF) to the 802.11ax stations to trigger uplink communications. A trigger frame is a control frame derived from a RTS frame with an additional payload to communicate additional signaling information like resource units allocation for example.

A resource unit can be reserved for a specific station, in which case the access point indicates, in the TF, the station to which the resource unit is reserved (the Association ID (AID) is provided to indicate which 802.11ax station is allowed to use the resource unit). Such resource unit is called a Scheduled resource unit. The indicated station does not need to perform contention on accessing a scheduled resource unit reserved to it.

Another kind of resource units can be accessed by any stations using contention access. Such resource unit is not allocated to a particular station. It means that the stations compete for accessing such resource units. Such resource units are called Random resource units, and are indicated in the Trigger Frame with special station identification (e.g., value of Association ID (AID) is 0).

Since the access point performs contention on behalf of the stations in this uplink OFDMA scheme, it is greatly preferable that the access point should be aware of which 802.11ax stations hold uplink packets to transmit and what their related emission buffer size amounts are.

The 802.11e standard brought the quality of service mechanism. According to this mechanism the previously unique emission buffer has been split into four different emission buffer corresponding to four different access categories. Each access category corresponds to two different priorities, each emission buffer consequently holds data having two different priorities. Each of the eight priority level is identified by a traffic identifier (TID). The 802.11e standard has also brought the mechanism of buffer status report (BSR). This mechanism provides a means for a station to report to the access point station the quantity of data held in an emission buffer ready to be transmitted to the access point station. The buffer status report mechanism is consequently adapted to report the quantity of data held in the emission buffers corresponding to a given TID.

Thanks to these reports, the access point is in charge of determining the width and duration of the uplink resource units for PPDU transmissions (PPDU length). All concerned 802.11ax stations (those explicitly solicited by the access point through a scheduled resource unit allocation, or those determined through applying the OFDMA random access procedure) make the uplink transmission with the indicated duration inside the indicated resource units. If a 802.11ax station's packet length is shorter or longer than the indicated duration, this packet should be padded or fragmented to make all uplink OFDMA transmissions finish at the same time. It is to be noted that the access point is free to offer different resource unit widths inside a same MU uplink transmission opportunity.

As one can note, buffer status knowledge has become the critical point for the access point, acting as the central control entity for MU uplink allocation: if stations without expected amount of uplink packets are polled for uplink OFDMA transmission, allocated uplink resources are wasted leading to system throughput degradation.

However, there are situations where the current usage of buffer size reports according to the 802.11 standard is not satisfactory, and conducting the access point to faulty allocate, to one or the other of these several stations, the resource units over which MU uplink communications may take place.

Exemplary situation is that transmission buffers of a 802.11ax station can be accessed by two transmission mechanisms: conventional EDCA-based CSMA and MU uplink OFDMA. As a consequence, buffer status reports (BSRs) communicated to the access point may not be always accurate. For example, by the time an access point gets from the buffer status report an amount of data present in the emitting station buffer, actual amount of data in the buffer may be lower if part of the data in the buffer has been transmitted in the meanwhile using conventional EDCA-based CSMA.

This may lower the efficiency of the bandwidth usage because the access point may schedule a size of a resource unit in the MU uplink mode that will not be completely used at the end by the station.

### SUMMARY OF INVENTION

The present invention has been devised to address one or more of the foregoing concerns.

According to a first aspect of the invention there is provided a method of communication in a wireless network comprising a plurality of wirelessly communicating stations, one station playing the role of access point, the other stations being connected to the access point station, the method comprising by the access point station:

receiving at least one buffer status report from a station indicating an amount of data the station has to transmit to the access point station;

storing received buffer status reports;

generating a channel resource allocation for a multi-user transmission from said stations to the access point station based on stored buffer status reports; wherein

said generation of a channel resource allocation further takes into account any amount of data received from said stations after said buffer status reports.

Accordingly, the allocation is more accurate and bandwidth is saved.

In an embodiment, said data received from said stations after said buffer status reports are received in single-user mode.

In an embodiment, the method further comprises:

sending a trigger frame for buffer status reports to said stations; the reception of said buffer status reports being a response to this trigger frame for buffer status reports.

In an embodiment, sending a trigger frame for buffer status reports is done one time over N times a channel resource allocation has to be generated, N being a positive integer.

Accordingly, the number of transmitted trigger frames for buffer status reports is reduced, bandwidth is saved.

In an embodiment, sending a trigger frame for buffer status reports is done before a channel resource allocation when the amount of data reported in stored buffer status reports is below a given threshold.

Accordingly, trigger frames for buffer status reports are transmitted only when needed, bandwidth is saved.

In an embodiment, the method further comprises:

upon reception of a data frame from one station, this data frame being transmitted according to either single-user mode or multi-user mode, and if a previous buffer status report is stored for this station, updating stored buffer status report according to the received data frame.

In an embodiment, updating stored buffer status report comprises replacing the stored buffer status report by a new buffer status report comprised within the received data frame.

Accordingly, any new data to be transmitted by the station is taken into account.

In an embodiment, updating stored buffer status report comprises subtracting from the stored buffer status report the amount of data received in the data frame.

In an embodiment, the method further comprises:

upon reception of a data frame from one station, and if no previous buffer status report is stored for this station, and if a buffer status report is comprised within the received data frame; storing the received buffer status report.

Accordingly the need to request buffer status reports is reduced.

According to another aspect of the invention there is provided a computer program product for a programmable apparatus, the computer program product comprising a sequence of instructions for implementing a method according to the invention, when loaded into and executed by the programmable apparatus.

According to another aspect of the invention there is provided a computer-readable storage medium storing instructions of a computer program for implementing a method according to the invention.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

Embodiments of the invention will now be described, by way of example only, and with reference to the following drawings in which:

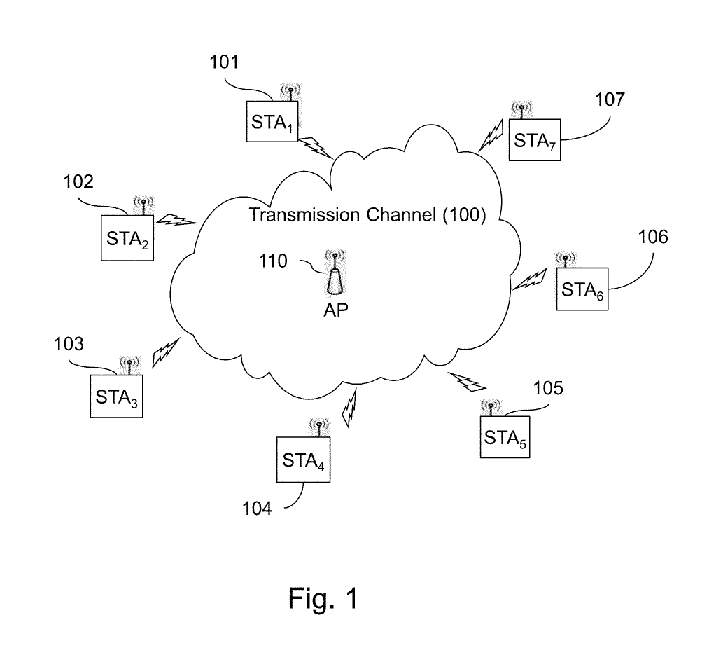

FIG. 1 illustrates a typical wireless communication system in which embodiments of the invention may be implemented;

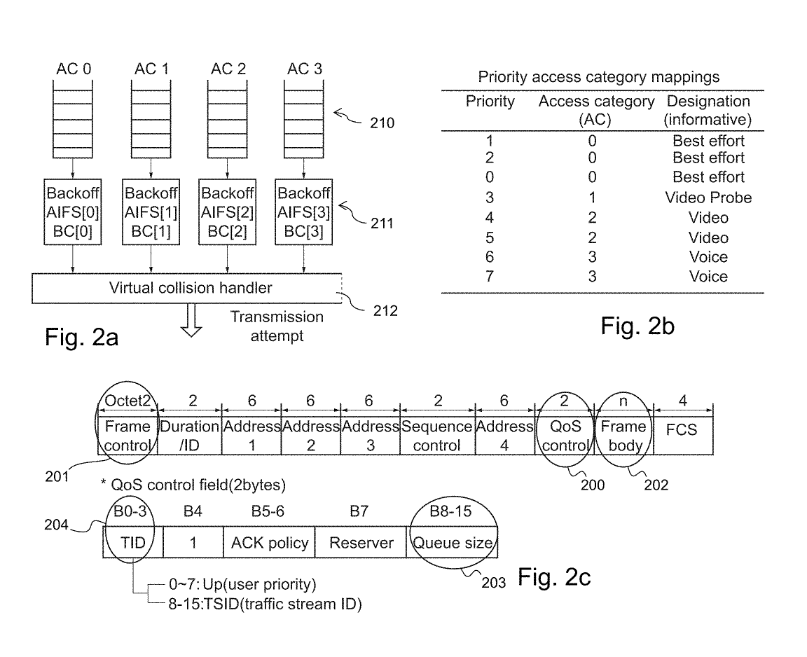

FIGS. 2a, 2b and 2c illustrate the IEEE 802.11e EDCA involving access categories;

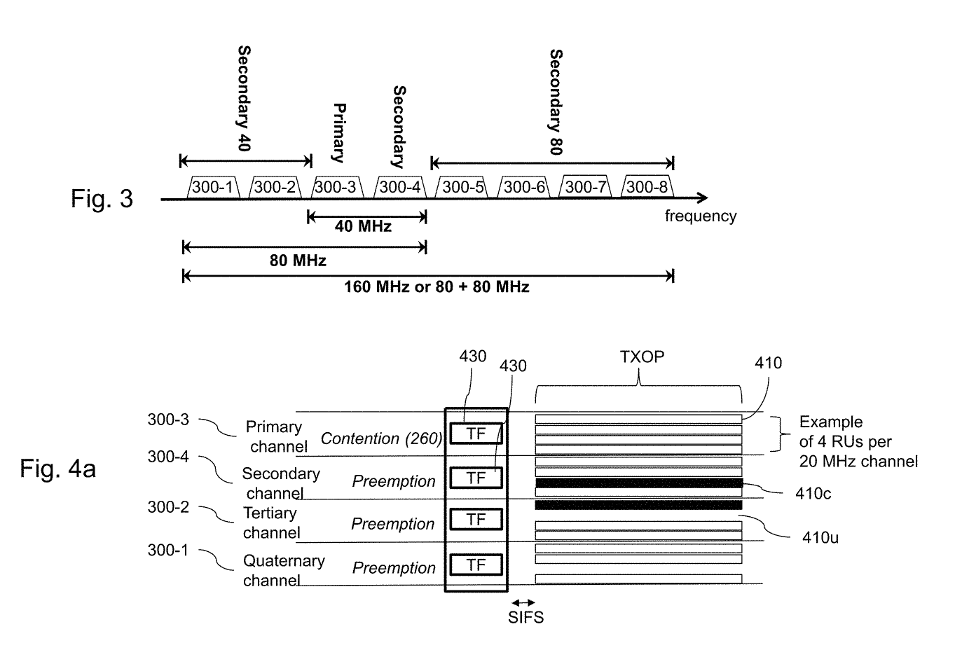

FIG. 3 illustrates 802.11ac channel allocation that supports composite channel bandwidths of 20 MHz, 40 MHz, 80 MHz or 160 MHz, as known in the art;

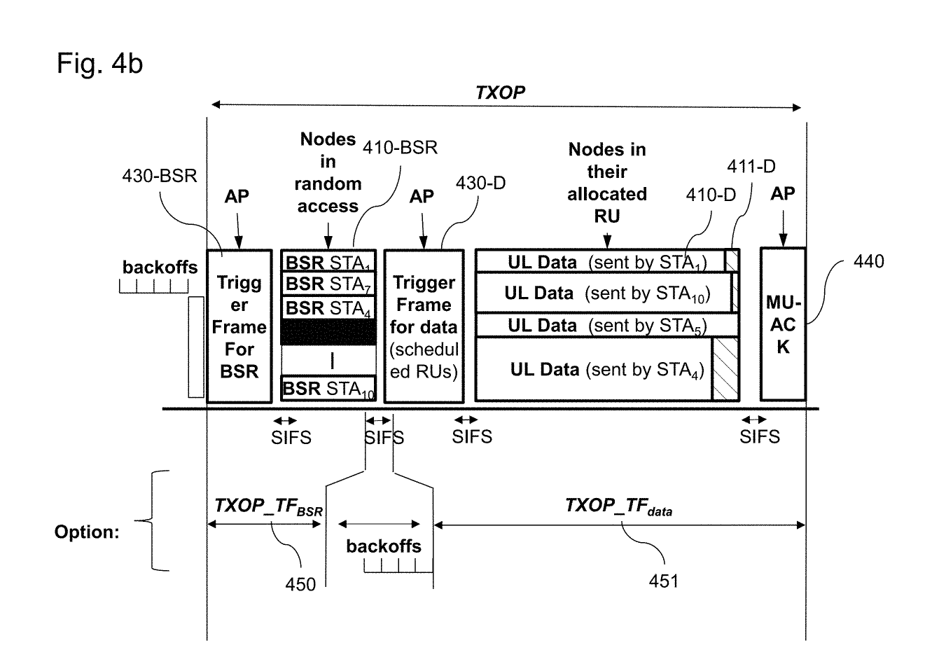

FIG. 4a illustrates, using a timeline, an example of 802.11ax OFDMA transmission scheme, wherein the access point issues a Trigger Frame for reserving a transmission opportunity of OFDMA resource units on an 80 MHz channel as known in the art;

FIG. 4b illustrates, using a timeline, an example of 802.11ax OFDMA transmission scheme, as known “buffer status feedback operation” by the 802.11ax standard, wherein the access point issues a sequence of two Trigger Frames for first requesting buffer status reports to 802.11ax stations and second scheduling OFDMA resource units to a subset of 802.11ax stations based on the collected buffer reports, over a transmission opportunity on an 80 MHz channel;

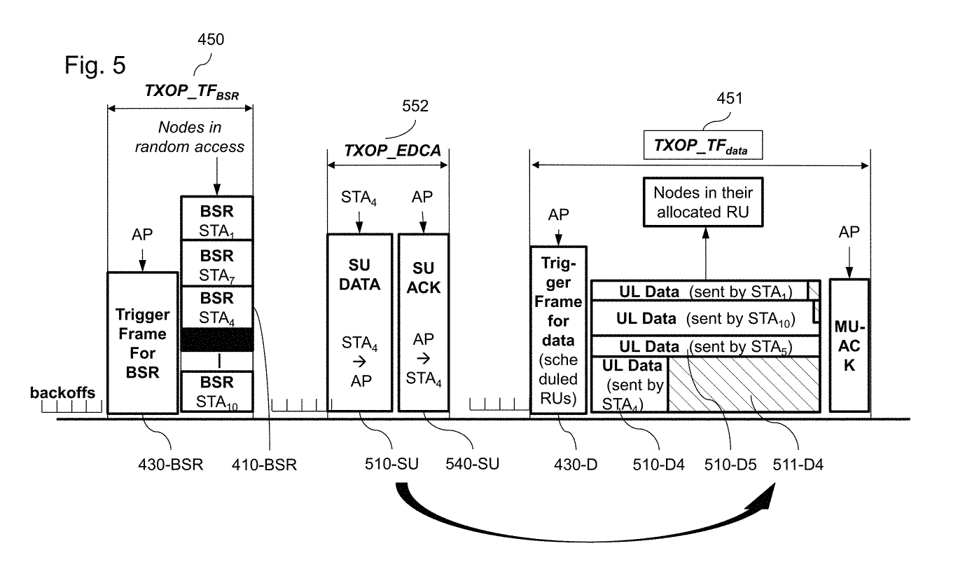

FIG. 5 illustrates, using a timeline, issues of the “buffer status feedback operation” scheme according 802.11ax standard;

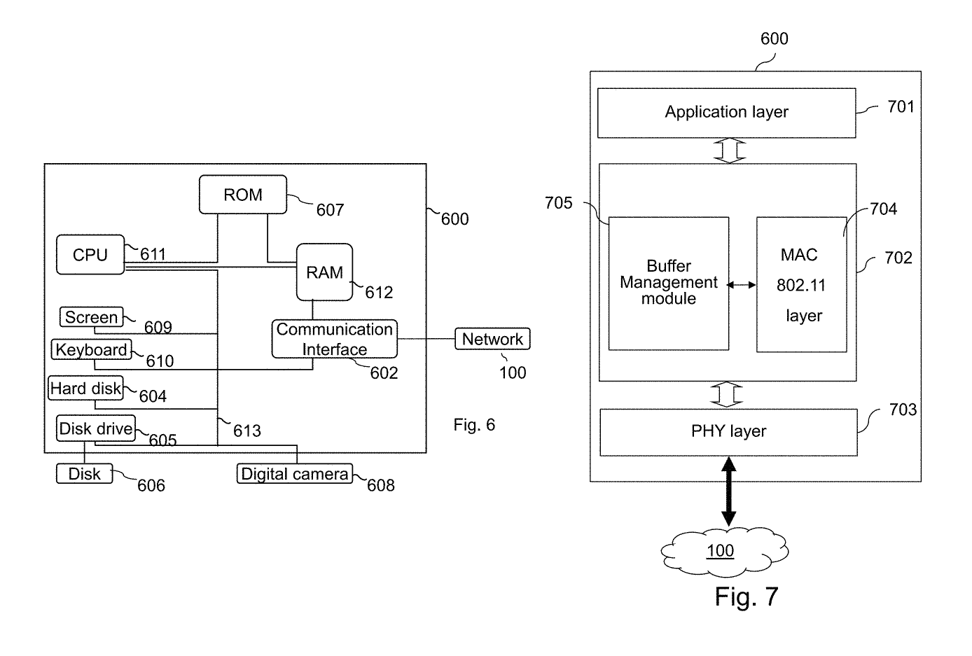

FIG. 6 shows a schematic representation a communication device in accordance with embodiments of the present invention;

FIG. 7 shows a block diagram schematically illustrating the architecture of a wireless communication device in accordance with embodiments of the present invention;

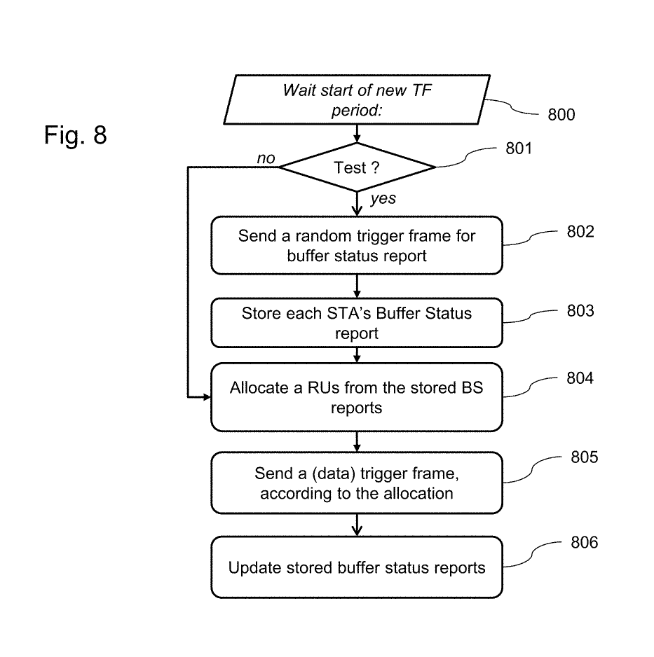

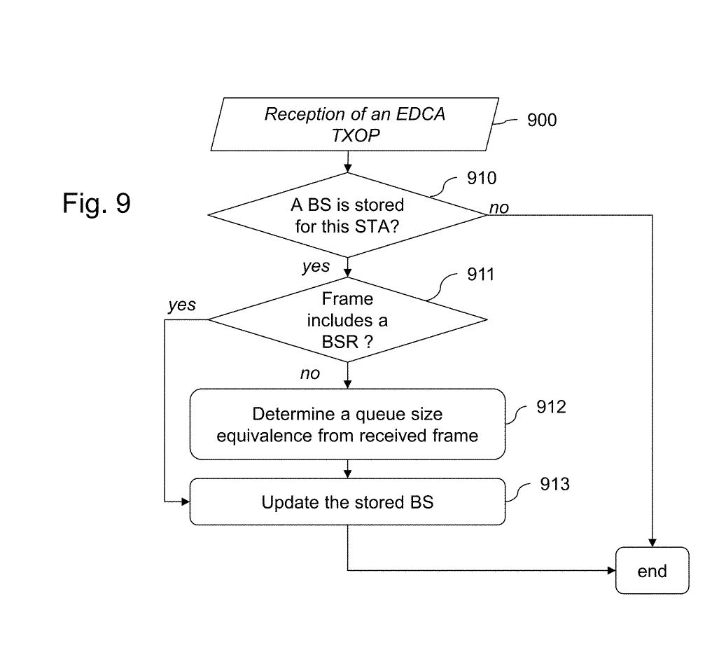

FIGS. 8 and 9 illustrate, using a flowchart, general steps at a 802.11ax Access Point of the network, according to embodiments of the invention;

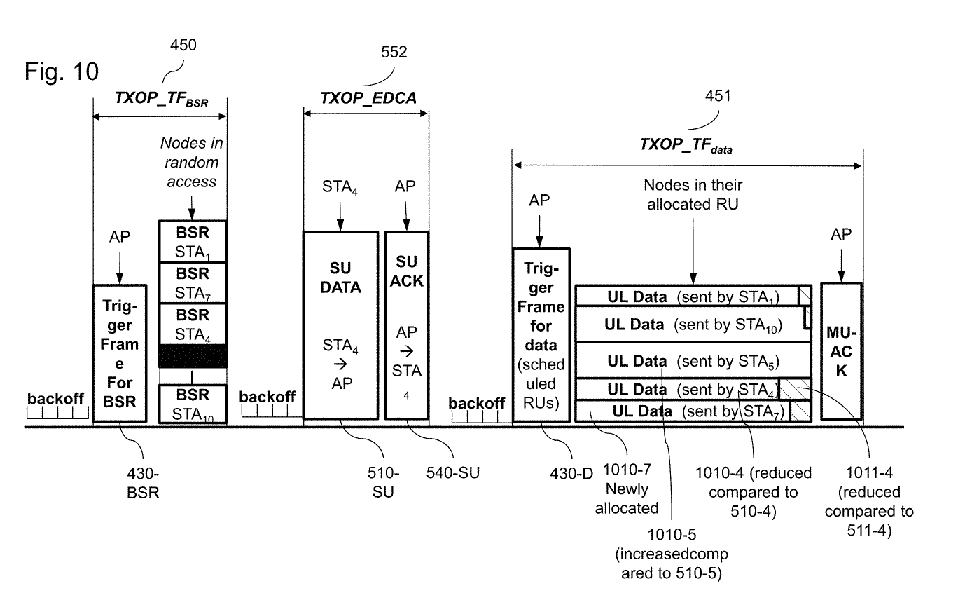

FIG. 10 illustrates, using a timeline, a scenario of reserving resource unit channels according to embodiments of the invention.

### DETAILED DESCRIPTION

The invention will now be described by means of specific non-limiting exemplary embodiments and by reference to the figures.

FIG. 1 illustrates a communication system in which several communication stations 101-107 exchange data frames over a radio transmission channel 100 of a wireless local area network (WLAN), under the management of a central station, or access point (AP) 110, also seen as a station of the network. The radio transmission channel 100 is defined by an operating frequency band constituted by a single channel or a plurality of channels forming a composite channel.

Access to the shared radio medium to send data frames is based on the CSMA/CA technique, for sensing the carrier and avoiding collision by separating concurrent transmissions in space and time. Carrier sensing in CSMA/CA is performed by both physical and virtual mechanisms. Virtual carrier sensing is achieved by transmitting control frames to reserve the medium prior to transmission of data frames. Next, a source or transmitting station first attempts, through the physical mechanism, to sense a medium that has been idle for at least one DIFS (standing for DCF InterFrame Spacing) time period, before transmitting data frames.

However, if it is sensed that the shared radio medium is busy during the DIFS period, the source station continues to wait until the radio medium becomes idle. Access to the medium is driven by a backoff counter (see FIG. 2a) that is decremented over time, to defer the transmission time for a random interval, thus reducing the probability of collisions on the shared channel. Upon the backoff time expiring, the source station may send data or control frames if the medium is idle.

The wireless communication system of FIG. 1 comprises a physical access point 110 configured to manage the WLAN BSS (Basic Service Set), namely a group of stations. Such BSS managed by an access point is called an infrastructure BSS. In the following, the term BSS will be used as an equivalent of infrastructure BSS. Once the BSS is established, meaning that the access point wakes up, it is organized around the access point which can bridge traffic out the BSS onto a distribution network, or inside the BSS. Thus, members of the BSS should talk to the access point only, which is in charge of relaying frames if targeted to another station of the BSS.

FIGS. 2a, 2b and 2c illustrate the IEEE 802.11e EDCA involving access categories, in order to improve the quality of service (QoS). In the original DCF standard, a communication station includes only one transmission queue/buffer. However, since a subsequent data frame cannot be transmitted until the transmission/retransmission of a preceding frame ends, the delay in transmitting/retransmitting the preceding frame prevents the communication from having QoS.

The IEEE 802.11e has overturned this deficiency in providing quality of service (QoS) enhancements to make more efficient use of the wireless medium. This standard relies on a coordination function, called Hybrid Coordination Function (HCF), which has two modes of operation: Enhanced Distributed Channel Access (EDCA) and HCF Controlled Channel Access (HCCA).

EDCA enhances or extends functionality of the original access DCF method: EDCA has been designed for support of prioritized traffic similar to DiffServ (Differentiated Services), which is a protocol for specifying and controlling network traffic by class so that certain types of traffic get precedence. EDCA is the dominant channel access mechanism in WLANs because it features a distributed and easily deployed mechanism. As will be apparent further in the description, the EDCA medium access is still existing in 802.11ax standard as the fundamental legacy protocol, that is to say it is in concurrency to the newly introduced Multi-User OFDMA of 802.11ax as illustrated in FIG. 3b.

The above deficiency of failing to have satisfactory QoS due to delay in frame retransmission has been solved with a plurality of transmission queues/buffers. QoS support in EDCA is achieved with the introduction of four Access Categories (ACs), and thereby of four corresponding transmission/traffic queues or buffers 210. Of course, another number of traffic queues may be contemplated. Each AC has its own traffic queue/buffer to store corresponding data frames to be transmitted on the network. The data frames, namely the MSDUs, incoming from an upper layer of the protocol stack are mapped onto one of the four AC queues/buffers and thus input in the mapped AC buffer.

Each AC has also its own set of channel access parameters or “queue backoff parameters”, and is associated with a priority value, thus defining traffic of higher or lower priority of MSDUs. Thus, there is a plurality of traffic queues for serving data traffic at different priorities. That means that each AC, and corresponding buffer, acts as an independent DCF contending entity including its respective queue backoff engine 211. Thus, each queue backoff engine 211 is associated with a respective traffic queue for computing a respective queue backoff value to be used to contend access to at least one communication channel in order to transmit data stored in the respective traffic queue.

It results that the ACs within the same communication station compete one with each other to access the wireless medium and to obtain a transmission opportunity. Service differentiation between the ACs is achieved by setting different queue backoff parameters between the ACs, such as different contention window parameters (CWₘᵢₙ, CWₘₐₓ), different arbitration interframe spaces (AIFS), and different transmission opportunity duration limits (TXOP_Limit).

With EDCA, high priority traffic has a higher chance of being sent than low priority traffic: a station with high priority traffic waits a little less (low CW) before it sends its packet, on average, than a station with low priority traffic.

The four AC buffers 210 are shown in FIG. 2a. Buffers AC3 and AC2 are usually reserved for real-time applications (e.g., voice or video transmission). They have, respectively, the highest priority and the penultimate highest priority. Buffers AC1 and AC0 are reserved for best effort and background traffic. They have, respectively, the penultimate lowest priority and the lowest priority.

Each data unit, MSDU, arriving at the MAC layer from an upper layer (e.g. Link layer) with a priority is mapped into an AC according to mapping rules. FIG. 2b shows an example of mapping between eight priorities of traffic class (User Priorities or UP, 0-7 according IEEE 802.1d) and the four ACs. The data frame is then stored in the buffer corresponding to the mapped AC.

When the EDCA backoff procedure for a traffic queue (or an AC) ends, the MAC controller (reference 704 in FIG. 7 below) of the transmitting station transmits a data frame from this traffic queue to the physical layer for transmission onto the wireless communication network.

Since the ACs operate concurrently in accessing the wireless medium, it may happen that two ACs of the same communication station have their backoff ending simultaneously. In such a situation, a virtual collision handler 212 of the MAC controller operates a selection of the AC having the highest priority, as shown in FIG. 2b, between the conflicting ACs, and gives up transmission of data frames from the ACs having lower priorities. Then, the virtual collision handler commands those ACs having lower priorities to start again a backoff operation using an increased CW value.

FIG. 2c illustrates configurations of a MAC data frame and a QoS control field 200 included in the header of the IEEE 802.11e MAC frame. The MAC data frame also includes, among other fields, a Frame Control header 201 and a frame body 202. As represented in the Figure, the QoS control field 200 is made of two bytes, including the following information items:
Bits B0 to B3 are used to store a traffic identifier (TID) 204 which identifies a traffic stream. The traffic identifier takes the value of the transmission priority value (User Priority UP, value between 0 and 7—see FIG. 2b) corresponding to the data conveyed by the data frame or takes the value of a traffic stream identifier, TSID, value between 8 and 15, for other data streams;
Bit B4 is used by a non-AP station to differentiate the meaning of bits B8-B15 and is detailed here below;
Bits B5 and B6 define the ACK policy subfield which specifies the acknowledgment policy associated with the data frame. This subfield is used to determine how the data frame has to be acknowledged by the receiving station; normal ACK, no ACK or Block ACK.
Bit B7 is reserved, meaning not used by the current 802.11 standards; and
If bit B4 is set to 1, bits B8-B15 represent the “queue size” subfield 203, to indicate the amount of buffered traffic for a given TID at the non-AP station sending this frame. The queue size value is the total size, rounded up to the nearest multiple of 256 octets and expressed in units of 256 octets, of all packets buffered for the specified TID. The access point may use this information to determine the next TXOP duration it will grant to the station. A queue size of 0 indicates the absence of any buffered traffic for that TID. A queue size of 255 indicates an unspecified or unknown size for that TID 204.
Alternatively to the “queue size” usage, if bit B4 is set to 0, bits B8-B15 represent the “TXOP Duration Requested” subfield. It indicates the duration, in units of 32 μs, that the sending station determines it needs for its next TXOP for the specified TID. Of course, the “TXOP Duration Requested” provides an equivalent request as the “queue size”, as they both consider all packets buffered for the specified TID.

The 802.11e MAC frame format, and more particularly the QoS Control field 200, have been kept for the up and comer standard versions as now described. The following description will be done with “queue size” format for the buffer status reports, as it is the largest usage. The invention remains applicable to the “TXOP Duration Requested” format.

To meet the ever-increasing demand for faster wireless networks to support bandwidth-intensive applications, 802.11ac is targeting larger bandwidth transmission through multi-channel operations. FIG. 3 illustrates 802.11ac channel allocation that supports composite channel bandwidth of 20 MHz, 40 MHz, 80 MHz or 160 MHz.

IEEE 802.11ac introduces support of a restricted number of predefined subsets of 20 MHz channels to form the sole predefined composite channel configurations that are available for reservation by any 802.11ac station on the wireless network to transmit data.

The predefined subsets are shown in FIG. 3 and correspond to 20 MHz, 40 MHz, 80 MHz, and 160 MHz channel bandwidths, compared to only 20 MHz and 40 MHz supported by 802.11n. Indeed, the 20 MHz component channels 300-1 to 300-8 are concatenated to form wider communication composite channels.

In the 802.11ac standard, the channels of each predefined 40 MHz, 80 MHz or 160 MHz subset are contiguous within the operating frequency band, i.e. no hole (missing channel) in the composite channel as ordered in the operating frequency band is allowed. As an exception, the 160 MHz channel bandwidth is composed of two 80 MHz channels that may or may not be frequency contiguous. The 80 MHz and 40 MHz channels are respectively composed of two frequencies adjacent or contiguous 40 MHz and 20 MHz channels, respectively. The present invention may have embodiments with either composition of the channel bandwidth, i.e. including only contiguous channels or formed of non-contiguous channels within the operating band.

A station is granted a TxOP through the enhanced distributed channel access (EDCA) mechanism on the “primary channel” 300-3. Indeed, for each composite channel having a bandwidth, 802.11ac designates one channel as “primary” meaning that it is used for contending for access to the composite channel. The primary 20 MHz channel is common to all stations belonging to the same basic set, i.e. managed by or registered to the same local Access Point (AP).

However, to make sure that no other legacy station (i.e. not belonging to the same set) uses the secondary channels, it is provided that the control frames (e.g. RTS frame/CTS frame) reserving the composite channel are duplicated over each 20 MHz channel of such composite channel.

As addressed earlier, the IEEE 802.11ac standard enables up to four, or even eight, 20 MHz channels to be bound. Because of the limited number of channels (19 in the 5 GHz band in Europe), channel saturation becomes problematic. Indeed, in densely populated areas, the 5 GHz band will surely tend to saturate even with a 20 or 40 MHz bandwidth usage per Wireless-LAN cell. Developments in the 802.11ax standard seek to enhance efficiency and usage of the wireless channel for dense environments.

In this perspective, one may consider multi-user (MU) transmission features, allowing multiple simultaneous transmissions to different users in both downlink and uplink directions. In the uplink (UL), multi-user transmissions can be used to mitigate the collision probability by allowing multiple stations to simultaneously transmit.

To actually perform such multi-user transmission, it has been proposed to split at least one granted 20 MHz channel 300-1 to 300-4 into elementary sub-channels 410 in FIG. 4a, also referred to as sub-carriers or resource units (RUs), that are shared in the frequency domain by multiple users, based for instance on Orthogonal Frequency Division Multiple Access (OFDMA) technique.

This is illustrated with reference to FIG. 4a which illustrates an example of OFDMA transmission scheme. In this example, each 20 MHz channel 300-1, 300-2, 300-3 or 300-4 is sub-divided in frequency domain into four OFDMA sub-channels or resource units 310 of size 5 MHz. These sub-channels (or resource units or sets of “sub-carriers”) may also be referred to as “traffic channels”.

Of course the number of resource units splitting a 20 MHz channel may be different from four. For instance, between two to nine resource units may be provided thus each having a size between 10 MHz and about 2 MHz. It is also possible to have a resource unit width greater than 20 MHz, when included inside a wider composite channel, for example 80 MHz. Contrary to downlink OFDMA wherein the access point can directly send multiple data to multiple stations, supported by specific indications inside the PLOP header, a trigger mechanism has been adopted for the access point to trigger uplink communications from various stations.

To support an uplink multi-user transmission, during a pre-empted TXOP, the 802.11ax access point has to provide signaling information for both legacy stations, namely non-802.11ax stations, to set their NAV to prevent any transmission during the TXOP, and for 802.11ax stations to determine the Resource Units allocation.

In the following description, the term legacy stations refer to non-802.11ax stations, meaning 802.11 stations of previous technologies that do not support OFDMA communications.

As shown in the example of FIG. 4a, the access point sends a trigger frame (TF) 430 to the targeted 802.11ax stations. The bandwidth or width of the targeted composite channel is signaled in the TF frame, meaning that the 20, 40, 80 or 160 MHz value is added. The TF frame is sent over the primary 20 MHz channel and duplicated, replicated, on each other 20 MHz channels forming the targeted composite channel. Thanks to the duplication of the trigger frame, it is expected that every nearby legacy station receiving the TF on its primary channel, then sets its NAV to the value specified in the TF frame. This prevents these legacy stations from accessing the channels of the targeted composite channel during the TXOP.

Based on an access point's decision, the trigger frame 430 may define a plurality of resource units (RUs) 410. The multi-user feature of OFDMA allows the access point to assign different resource units to different stations in order to increase competition. This may help to reduce contention and collisions inside 802.11 networks.

The trigger frame 430 may designate “Scheduled resource units”, which may be reserved by the access point for certain stations in which case no contention for accessing such resource units is needed for these stations. Such resource units and their corresponding scheduled stations are indicated in the trigger frame. For instance, a station identifier, such as the Association ID (AID) assigned to each station upon registration, is added in association with each scheduled resource unit in order to explicitly indicate the station that is allowed to use each Scheduled resource unit. Such transmission mode is concurrent to the classical EDCA, and the uplink data to be sent to the access point is picked from the EDCA queues 210.

The trigger frame 430 may also designate “Random resource units”, in addition or in replacement of the “Scheduled resource units”, which can be randomly accessed by the stations of the network. In other words, Random resource units designated or allocated by the access point in the TF may serve as basis for contention between stations willing to access the communication medium for sending data. A collision occurs when two or more stations attempt to transmit at the same time over the same resource unit. An AID equal to 0 may be used to identify random resource units.

A random allocation procedure is under definition by 802.11ax standard, and is based on a new backoff counter (OFDMA backoff, or OBO) inside the 802.11ax non-AP stations for allowing a contention in a resource unit to send data. This OBO backoff, while in concurrence to the EDCA backoff engines 211 for allowing transmission onto the wireless channel, will empty the same EDCA queues 210. The OFDMA random allocation procedure comprises, for a station of a plurality of 802.11ax stations having an positive OBO backoff value, initially drawn inside an OFDMA contention window range, a first step of determining from a received trigger frame the sub-channels or resource units of the communication medium available for contention (the so-called “random resource units”), a second step of verifying if the value of the OBO backoff value local to the considered station is not greater than the number of detected-as-available random resource units, and then, in case of successful verification, a third step of randomly selecting a resource unit among the detected-as-available resource units for sending data. In case of second step is not verified, a fourth step (instead of the third) is performed in order to decrement the OBO backoff value by the number of detected-as-available random resource units.

As one can note, an OFDMA transmission according random procedure is not ensured for each trigger frame reception: at least the OBO is decremented upon each reception of a trigger frame with “random resource units”, which differs transmission to any one of subsequent trigger frames depending of OBO value and number of random resource units offered by those further received TFs.

In the example of FIG. 4a, each 20 MHz channel 400-1, 400-2, 400-3 or 400-4 is sub-divided in frequency domain into four sub-channels or resource units 410, typically of size 5 MHz. Of course the number of resource units splitting a 20 MHz channel may be different from four. For instance, between two to nine resource units may be provided, thus each having a size between 10 MHz and about 2 MHz.

As shown in FIG. 4a, some Resource Units 410u may not be used because no station with an OBO backoff value less than the number of available random resource units has randomly selected one of these resource units, whereas some other 410c are collided, the black ones on FIG. 4a, because at least two of these stations have randomly selected the same random resource unit. This shows that due to the random determination of random resource units to access, collision may occur over some resource units, while other resource units may remain free. The used resource units 410 may be fit by stations following the allocation scheme information, namely the value AID, provided inside the trigger frame, scheduled to a given AID non-zero value, or random when AID equals zero. Once the stations have used the resource units to transmit data to the access point, the access point responds with a Multi-User acknowledgment, not show in FIG. 4a, to acknowledge the data on each resource unit.

FIG. 4b provides an exemplary scenario of 802.11ax, wherein successive trigger frames, first fully random-type then second fully scheduled-type, are used in order that an access point polls stations having uplink data.

Since the receiver, the access point, performs contention on behalf of the non-AP stations in the uplink OFDMA, the access point should be aware of both which non-AP stations have uplink packets and what their buffer 210 sizes are. If non-AP stations without uplink packets are polled for uplink OFDMA transmission, then allocated uplink resources are wasted thus leading to wireless medium usage degradation.

The standard proposes that buffer status report from 802.11ax stations may be utilized to support the efficient uplink MU operation by the access point. Upon reception of a trigger frame 430-BSR containing a request indication of buffer status report, a 802.11ax station responds with a frame including the Queue Size subfield 203 in its QoS Control field 200. The indication of buffer status report may be, for example, a “Trigger Type” provided inside the Trigger Frame, and a specific value indicates such buffer status request. The trigger frame 430-BSR is seen as a trigger frame for Buffer Status Report (BSR) by the station.

Preferably, the trigger frame 430-BSR is emitted in broadcast in order to reach all stations of the BSS, and the, most even all, resource units are of random-type to allow any station a random opportunity to provide a queue size report. In addition, it is preferable to try to reach a maximum of stations, then the maximum number of resource units should be provided, that is to say among the widest channel band and with the narrowest resource unit sizes.

In order to minimize the duration of the buffer state report, the frames sent inside resource units 410-BSR should be limited and of same size to avoiding inefficient padding. For example, a QoS_Null frame seems better appropriated. This specific QoS Data frame contains the QoS Control field with queue size information, but no data payload.). It should be noticed that the trigger frame follows the legacy format of 802.11 control frames. Like an RTS frame, there is no specific HT preamble and frame is duplicated in each 20 MHz channel of the targeted composite channel in low modulation to set the NAV of all legacy devices. So the timing overhead of one TF is important.

A current version of IEEE 802.11ax extends the usage of Queue size information 203 in a new QoS Control field, namely HE Control, and possibly in replacement of QoS Control field for 802.11ax frames, in order to inform about the several queues 210, instead on only one, according to 802.11e.

Once the access point has obtained buffer reports for a set of stations of its BSS, it can specifically poll them through scheduled resource unit allocation. This allocation is transmitted using a trigger frame 430-D for data transmission sometimes called “classical” or “basic type” trigger frame. Then, the stations with allocated resource units emits their buffered data during a longer trigger frame for data 451 and inside their allocated resource unit 410-D. As the MU UL/DL OFDMA transmissions on all the resource units of the composite channel should be aligned in time, the station may provide padding payload 411-D in case of no more data can be sent inside the assigned resource unit. This may happen, for example, if no more data is buffered for transmission, or if the emitting station doesn't want to fragment any remaining data frame.

The access point is able to manage the resource unit size according to the reported needs. The access point may schedule the uplink resource unit(s) during the TXOP period to any of the stations having sent a report.

Once the stations have used the resource units 410-D to transmit data to the access point, the access point responds with a Multi-User acknowledgment 440 to acknowledge the data on each resource unit. This ACK ends the granted TXOP period.

Regarding the organization of TXOP, two embodiments may be contemplated. In a first embodiment, the whole transmission, namely the trigger frame for buffer status report 430-BSR, the buffer status report response 410-BSR from the stations, the trigger frame for data 430-D, the data transmission 410-D, 411-D and acknowledgement 440 are grouped into an unique TXOP 452. In a second embodiment, a first TXOP, TXOP_TF_{BSR}, is provided for the trigger frame for buffer status report 430-BSR and the buffer status report response 410-BSR from the stations. Next, the channel is released. A second TXOP, TXOP_TF_{data}, is provided for the trigger frame for data 430-D, the data transmission 410-D, 411-D and acknowledgement 440.

It is up to the access point to decide if first and second TXOPs are separated or pertaining to a unique TXOP, in which case only a SIFS delay is mandatory before emitting the trigger frame 430-D.

It is to be noted that there are always two trigger frames required for that scheme, in order to ensure accurate buffer information. This overhead is very detrimental to wireless resources, especially in dense environments as addressed by the 802.11ax standard.

FIG. 5 provides a demonstrative scenario, wherein the theoretical scenario of FIG. 4a envisaged by the 802.11ax standard suffers from additional inefficiencies. As recalled, EDCA communications inside the infrastructure BSS group are concurrent to OFDMA uplink communications. That is, the 802.11ax stations have their transmission queues served with data from two transmission mechanisms.

FIG. 5 demonstrates that the 802.11ax usage for using buffer status reports is not adapted to this transmission concurrency. Originally, a buffer status report contains information on data which is buffered for a unique communication scheme. For the example, we consider that the station 4 has reported in a buffer status report 410-BSR an important buffer occupation to the access point, and would like to be offered a great opportunity to transmit its data.

As raised in regards to FIG. 4b, the access point aims to optimize the channel usage and would expect to relax the constraint of obtaining buffer status reports, through TXOP_TF_{BSR} 450, for stations prior to each allocation of uplink resource units. In other words, it would be an objective for the access point to have the buffer status reports obtained still applicable for several data TXOP 451.

Because of the EDCA/UL OFDMA concurrence, this is not possible to extend the lifetime of the reports. In detail, due to random nature of backoff procedure, it is impossible for an access point to guarantee that the EDCA backoff(s) of the 802.11ax stations will expire after their OBO backoff, namely that EDCA occurs after a next uplink OFDMA TXOP. Then, some TXOP_EDCA 552 will occur regularly in between data trigger frames, like any legacy ECDA access.

This conducts to a false usage of the reports by the access point, which is misled for allocation of resource units to 802.11ax stations in allocated data TXOP 451 because of the presence of EDCA TXOP 552 of one of the station having previously provided its buffer status report in a buffer status report TXOP 450.

This situation conducts the access point to allocate a large resource unit for uplink data of station 4. As a consequence, the allocated resource unit is composed of a data portion 510-D4 followed by an important padding 511-D4, because the access point grants uplink resources to a station 4 which finally is not able to use the offered resource. The reason is that most of data the station 4 had to transmit was previously conveyed in the EDCA TXOP 552, namely these are data 510-SU. This padding is pure lost, and may represent the quasi totality of the resource unit.

This issue is really detrimental for dense scenarios addressed by 802.11ax, for at least the following reasons. Important resource unit allocation may not be used. In addition to a worse efficiency of the global system, energy for transmitting padding is consumed by the 802.11ax station. Some 802.11ax stations with pending uplink traffic get no allocation, and their buffers are crowding. This is, for example, the case of station 7 which has sent a buffer report, but has not obtained any allocated resource unit. As a result, such stations will try emptying their transmission buffers through EDCA medium accesses, which increases collision probability.

As a result, the 802.11ax standardization recommends the scenario relying of the two Trigger frame sequence, as shown in FIG. 4, even if it provides such major deficiencies in the wireless usage.

The present invention seeks to improve the reservation of the resource units for multi-user transmission. To do so, an aim of this invention is to provide means for an 802.11ax access point to update its received buffer status reports obtained from an 802.11ax stations, according the perceived transmissions inside its managed BSS.

While embodiments of the invention are described in an IEEE 802.11ax network and its future versions, the invention applies to any wireless network comprising stations, for instance an access point 110 and a plurality of stations 101-107, exchanging data through different transmission modes.

An exemplary management of single-user (EDCA) and multi-user transmissions (UL-OFDMA) in such a network has been described above with reference to FIGS. 1 to 5.

FIG. 6 schematically illustrates a communication device 600 of the radio network 100, configured to implement at least one embodiment of the present invention. The communication device 600 may preferably be a device such as a micro-computer, a workstation or a light portable device. The communication device 600 comprises a communication bus 613 to which there are preferably connected:
a central processing unit 611, such as a microprocessor, denoted CPU;
a read only memory 607, denoted ROM, for storing computer programs for implementing the invention;
a random access memory 612, denoted RAM, for storing the executable code of methods according to embodiments of the invention as well as the registers adapted to record variables and parameters necessary for implementing methods according to embodiments of the invention; and
at least one communication interface 602 connected to the radio communication network 100 over which digital data packets or frames or control frames are transmitted, for example a wireless communication network according to the 802.11ax protocol. The frames are written from a FIFO sending memory in RAM 612 to the network interface for transmission or are read from the network interface for reception and writing into a FIFO receiving memory in RAM 612 under the control of a software application running in the CPU 611.

Optionally, the communication device 600 may also include the following components:
a data storage means 604 such as a hard disk, for storing computer programs for implementing methods according to one or more embodiments of the invention;
a disk drive 605 for a disk 606, the disk drive being adapted to read data from the disk 606 or to write data onto said disk;
a screen 609 for displaying decoded data and/or serving as a graphical interface with the user, by means of a keyboard 610 or any other pointing means.

The communication device 600 may be optionally connected to various peripherals, such as for example a digital camera 608, each being connected to an input/output card (not shown) so as to supply data to the communication device 600.

Preferably the communication bus provides communication and interoperability between the various elements included in the communication device 600 or connected to it. The representation of the bus is not limiting and in particular the central processing unit is operable to communicate instructions to any element of the communication device 600 directly or by means of another element of the communication device 600.

The disk 606 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to the invention to be implemented.

The executable code may optionally be stored either in read only memory 607, on the hard disk 604 or on a removable digital medium such as for example a disk 606 as described previously. According to an optional variant, the executable code of the programs can be received by means of the communication network 603, via the interface 602, in order to be stored in one of the storage means of the communication device 600, such as the hard disk 604, before being executed.

The central processing unit 611 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 604 or in the read only memory 607, are transferred into the random access memory 612, which then contains the executable code of the program or programs, as well as registers for storing the variables and parameters necessary for implementing the invention.

In a preferred embodiment, the apparatus is a programmable apparatus which uses software to implement the invention. However, alternatively, the present invention may be implemented in hardware (for example, in the form of an Application Specific Integrated Circuit or ASIC).

FIG. 7 is a block diagram schematically illustrating the logical architecture of the communication device or station 600, typically the access point 110 adapted to carry out, at least partially, the invention. As illustrated, station 600 comprises a physical (PHY) layer block 703, a MAC layer block 702, and an application layer block 701.

The PHY layer block 703 (e.g. a 802.11 standardized PHY layer) has the task of formatting, modulating on or demodulating from any 20 MHz channel or the composite channel, and thus sending or receiving frames over the radio medium used 100, such as 802.11 frames, for instance single-user frames, such as control frames (RTS/CTS/ACK/Trigger Frame), MAC data and management frames, based on a 20 MHz width to interact with 802.11 stations in legacy mode, as well as MAC data frames of OFDMA type having smaller width than 20 MHz legacy (typically 2 or 5 MHz) to/from that radio medium.

The MAC layer block or controller 702 preferably comprises a MAC 802.11 layer 704 implementing conventional 802.11ax MAC operations, and one additional block 705 for carrying out, at least partially, embodiments of the invention. The MAC layer block 702 may optionally be implemented in software, which software is loaded into RAM 612 and executed by CPU 611.

Preferably, the additional block 705 is a buffer management module which drives the AP node in requesting and receiving buffer size information to/from 802.11ax stations and keeping up-to-date these reports. For instance and not exhaustively, the AP station will consider the EDCA transmissions of the 802.11ax stations for updating corresponding reported buffer information, and allocating uplink OFDMA resources to these 802.11ax stations.

On top of the Figure, application layer block 701 runs an application that generates and receives data packets, for example data packets of a video stream. Application layer block 701 represents all the stack layers above MAC layer according to ISO standardization.

Embodiments of the present invention are now illustrated through different flowcharts describing the behaviour at the access point 110 in relation with FIGS. 8 and 9. They are described in the context of IEEE 802.11ax by considering OFDMA sub-channels.

FIG. 8 is a flowchart illustrating main steps of the process at access point 110 when emitting a resource unit allocation through a trigger frame.

At step 800, the access point prepares to emit a new uplink TXOP for polling some stations of its BSS. For example, the access point may schedule channel access times for some 802.11ax stations.

As the access point emits Trigger Frame through EDCA mechanism, it may usually be stored inside one of the EDCA queue of the access point. It will typically be inserted within the AC_3 queue for VOICE in order to have a better priority probability to be sent quickly compared to the other queues 210.

The steps 802 and 803 are related to obtaining buffer status report , through a trigger frame for buffer status reports 430-BSR. In a preferred embodiment, trigger frames for buffer status reports transmitted by the access point may contain only resource units for random access.

The steps 804 and 805 are related to allocation of uplink resource units by the access point to some 802.11ax stations, through a trigger frame for data 430-D. In a preferred embodiment, trigger frames for data transmitted by the access point may contain no resource unit for random access, but all resource units are scheduled.

According to one aspect of the invention a test 801 is provided in order to limit the execution of steps 802 and 803, and avoids sending too much trigger frames for buffer status reports which are time consuming on the wireless medium. That is, the access point sends several scheduled trigger frames for data before requesting a complete buffer status from TF_{BSR}.

According to a first embodiment, the test 801 consists in testing the occurrence of the test against a predefined number. The test will return true, the first time the test is executed and next every N times the test is executed. For example, the test will return true every 3 times it is executed and false the other time. Accordingly, steps 802 and 803 will be executed the first time the access point has planned to poll the stations for data through a scheduled data trigger frame. Next, steps 802 and 803 will only be executed once every three occurrences of the test. The two other times, the step 804 determining the allocation of resource units will be directly executed. Accordingly, the number of times the trigger frame for buffer status report is emitted by the access point is divided by three.

According to another embodiment, the test 801 consists in testing the value of the stored buffer status reports. These buffer status reports are received and stored for each station in response to a trigger frame for status report. According to an aspect of the invention, their values are next updated each time the access point received data from the stations, either in EDCA mode or within a scheduled data frame. Accordingly, the access point knows at any moment, based on the last received buffer status report, the quantity of data stations has, at least, in its emission buffer to be transmitted to the access point. We say “at least” because a station may have received from its application level new fresh data to transmit since the last time it reported a buffer status report. These new fresh data are not known to the access point until a new buffer status report is sent by the station. Based on the updated values of the stored buffer status report, the access point is able to determine if it is remaining enough data to generate a scheduled data frame, that reasonably fill the available bandwidth. The test 801 consists typically in a comparison of the remaining quantity of data to be transmitted by the stations, according to stored buffer status reports, with a predetermined threshold.

According to yet another embodiment, the test 801 is simply skipped. Namely, steps 802 and 803 are always executed before generating a trigger frame for data. In this embodiment, there is no saving on the number of trigger frames for buffer status report which are sent before any trigger frame for data. This embodiment is still advantageous. By storing the buffer status reports and updating them every time data are received by the access point, this embodiment takes into account the case where a station transmits an EDCA data frame between the transmission of its buffer status report and the generation of the trigger frame for data. Accordingly, the buffer status report of this station will be updated by subtracting the amount of data received in the EDCA data frame, and the allocation generated to produce the trigger frame for data will adequately reflect the amount of data the station has still to transmit. Thus not extra reservation will be generated, leading to prejudicial data padding in the response to the trigger frame for data.

Step 802 consists in emitting a buffer status request, as example via a random access trigger frame for buffer status report.

Step 803 stores all received entries, erasing the existing values in case a stored buffer status report is already present.

In a preferred embodiment, the access point destroys all existing buffer information entries in step 802, before storing the newly received ones in step 803. Thus, the access point will only allocate resource units to stations which have successfully reached to emit their buffer status in random resource units.

In step 804, traditionally, the access point can specifically poll some of the stations, having provided a buffer status report, through scheduled resource units allocations. According to the invention, as the access point monitors all traffics, including EDCA traffic, to keep the received buffer status reports accurate, it may adjust the granularity of traffic type allowed inside a scheduled resource unit. For example, the access point may poll some detected-EDCA stations explicitly for TIDs or ACs that were not conveyed through the detected TXOP_EDCA 552.

Next, in step 806, the buffer status reports of emitting stations will be updated by subtracting the amount of data received during the uplink multi-user OFDMA transmission phase 451. In an embodiment, when received data frames contain a buffer status report, the received status reports replace the previously stored buffer status reports.

In FIG. 9, at step 900, a new MPDU frame is received via an EDCA mode at the access point, note the access point is the central entity where all 802.11 frames are relayed due to infrastructure BSS. This 802.11 MPDU frame will be analysed to determine the address of the recipient, and the concerned traffic identifier (TID). As there is potentially an aggregation of 802.11 MPDU frames, the algorithm of FIG. 9 is performed for each frame (MPDU) aggregated inside the aggregate frame (AMPDU).

Based on the emitting MAC address of the MPDU, test 910 consists in verifying if a buffer report information is already stored for this 802.11ax station. If not the case, there is no risk of buffer information inconsistency, so the algorithm ends.

Otherwise, it means that a buffer information is stored by the access point for this station and TID.

In a non-represented alternative, if test 910 finds no buffer information for the sender station, the control passes to step 913 where a buffer status entry is created under the condition that the received frame contains a buffer status report consisting in a valid “queue size” report 203. This complements the buffer information at the access point, in case of the concerned station had failed to obtained a random resource unit in the prior trigger frame for buffer status report or has failed to transmit its buffer status report, for example due to collision. In case of aggregation, several MPDUs of various TIDs may be aggregated, so the final buffer status report information obtained from the received EDCA aggregated frame can be as rich as the multiple-TID buffer status report that the access point could have obtained through a trigger frame for buffer status report according to uplink OFDMA mode.

Test 911 directs to step 912 in case of no buffer status report 203 is available in the incoming frame. This test has to be done because the use of queue size 203 in 802.11e QoS Control field is not mandatory. This is to calculate an estimation of consumed data at the sender station for the received frame. There are several methods to determine the data size (that is to say MSDU size) of the received MPDU frame. It is possible to use the PHY header. It is also possible to read the A-MPDU delimiter for each aggregated MPDU, wherein a length is provided. Another alternative is to use the Duration/ID field of MAC header along with channel width to compute a frame size. Yet another alternative is to read the MSDU's packet size which is encapsulated inside the MPDU.

The obtained estimated size is subtracted to the stored buffer status entry in step 913. In case a buffer status report is already present in the frame, namely the test 911 is positive, the stored buffer status entry is just replaced with the provided value.

Preferably, the algorithm of FIG. 9 is executed for successful EDCA transmissions, namely when a positive acknowledgment 540-SU is to be emitted by the access point.

The algorithm of FIG. 9 presents a computation of an estimated minimum amount of data still stored at a given 802.11ax station. It cannot help to estimate the real amount of buffers, especially is not able to determine newly coming MSDU in the station emission buffers. But, by this minimum estimation, the access point is ensured that the stations, at which it has granted a resource unit, will fully use their granted channel resource 410.

FIG. 10 illustrates, using a timeline, a scenario of improving the wireless channel usage according to embodiments of the invention, and more specifically allocating more efficiently the resource unit channels to the 802.11ax stations for their uplink needs. This timeline describes the various effects of invention in regards to the issues raised by FIG. 5 in the context of 802.11ax.

According to a first aspect of the described embodiment, the access point monitors the uplink traffic among the overall communication schemes (EDCA or OFDMA), the buffer status report information is updated with traffic received over either communication mode. Accordingly, the buffer status report information is more accurate, even if data have been received later than the buffer status reports, when the allocation of channel resources is done to generate a trigger frame for data.

In some embodiment, a conventional trigger frame for buffer status report 430-BSR is no longer required before each trigger frame for data 430-D, thus saving bandwidth. Buffer Status Reports are less often requested by the access point. Accordingly the consistency of the buffer status reports is extended in time. The reporting time constraint of explicit buffer status report query is also extended. This allows saving bandwidth.

If a buffer status report is missing, typically from stations which have collided in trying to obtain a resource unit via uplink OFDMA with random access, due to dense environment, the buffer information is kept reliable according to the detected EDCA traffic. Moreover, the missing buffer report may be obtained from the other one of the communication mode, namely the EDCA.

By monitoring EDCA single-user communications, for example 510-SU, the access point keeps knowledge of the minimum needs of 802.11ax stations, and is ensured to have fully filled resource units by the 802.11ax stations, saving bandwidth.

For example, in FIG. 10, the access point is informed about a limited need for station 4, greatly reduced compared to the situation of FIG. 5. As a result, the allocated resource unit for station 4 is reduced. The amount of emitted data is comparable to 510-4, even if the distribution is different as the resource unit is finer. More important, the padding 1011-4 has mostly disappeared compared to the 511-4.

This leaves room for the access point to allocate resource units to other stations, such as station 7, see the QoS Data 1010-7 which now has opportunity to transmit, and such as for example station 5 which is offered a larger resource unit 1010-5.

However, in other embodiments, the access point may decide to postpone station 4 uplink transmission to a later TXOP, thus liberating more wireless resources for other stations of the BSS.

Thanks to monitoring by the access point of 802.11ax stations' traffics according to the invention, the resource unit allocation is more efficient in dense scenarios like envisaged in 802.11ax, the allocation of uplink resources by the access point is performed in regards to the real minimum need of stations.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of communication in a wireless network comprising a plurality of wirelessly communicating stations, one station playing the role of access point, the other stations being connected to the access point station, the method comprising by the access point station:
receiving at least one buffer status report from a station indicating an amount of data the station has to transmit to the access point station;
storing received buffer status reports;
generating a channel resource allocation for a multi-user transmission from the stations to the access point station based on stored buffer status reports;
wherein the generation of a channel resource allocation further takes into account any amount of data received from the stations after the buffer status reports; and
upon reception of a data frame from one station, and if a buffer status report is comprised within the received data frame, storing the received buffer status report.

2. The method of claim 1, wherein the data received from the stations after the buffer status reports is received in single-user mode.

3. The method of claim 1, further comprising:
sending a trigger frame for buffer status reports to the stations; the reception of the buffer status reports being a response to this trigger frame for buffer status reports.

4. The method of claim 3, wherein:
sending a trigger frame for buffer status reports is done one time over N times a channel resource allocation has to be generated, N being a positive integer.

5. The method of claim 3, wherein sending a trigger frame for buffer status reports is done before a channel resource allocation when the amount of data reported in stored buffer status reports is below a given threshold.

6. The method of claim 1, wherein the method further comprises:
upon reception of a data frame from one station, this data frame being transmitted according to either single-user mode or multi-user mode, and if a previous buffer status report is stored for this station, updating stored buffer status report according to the received data frame.

7. The method of claim 6, wherein updating stored buffer status report comprises replacing the stored buffer status report by a new buffer status report comprised within the received data frame.

8. The method of claim 6, wherein updating stored buffer status report comprises subtracting from the stored buffer status report the amount of data received in the data frame.

9. A computer-readable storage medium storing instructions of a computer program for implementing a method according to claim 1.
